(19) United States
(12) Patent Application Publication
(10) Pub. No.: US 2011/0270658 A1
(43) Pub. Date: Nov. 3, 2011

(54) SYSTEM AND METHOD FOR DISTRIBUTING PRINTED ADVERTISING INFORMATION MESSAGES DURING MONEY TRANSFER AND PAYMENTS

(76) Inventor: Natalia P. Katina, Moscow (RU)

(21) Appl. No.: 13/058,652

(22) PCT Filed: Jul. 30, 2009
(86) PCT No.: PCT/RU2009/000377

§ 371 Date: Apr. 12, 2011

(30) Foreign Application Priority Data
Aug. 11, 2008 (RU) 2008132765

(51) Int. Cl. G06Q 30/00

(52) U.S. Cl. 705/14.23; 705/14.51

(57) ABSTRACT

System and method of distribution of printed advertising informational messages when money transfers and payments is related to the sphere of electronic distribution of advertising informational materials and can be used by the systems of international and local money transfer and/or systems of payments collecting and/or technical provider which functions include save, rout, sort and distribute information among the systems of transfers and payments rendering services to the companies and individuals. And the delivery of the advertising informational messages is administrated by the advertising module of informational system uniting via technological solution the work of financial and advertising modules and provide the selective delivery of the advertising modules to the accordingly identified group of the clients to the terminals of applications for the printing on the hardcopy of the electronic form of services rendering and the selective criteria for the certain audience of the concrete advertising module can be the given by the advertiser the amount of transfer and/or entering in an account of the client.

The invention is related to the sphere of electronic distribution of advertising informational materials and can be used by the systems of international and local money transfer and/or systems of payments collecting and/or technical provider which functions include save, rout, sort and distribute information among the systems of transfers and payments rendering services to the companies and individuals. Particularly advertising informational materials can be distributed via terminals of apply as well as via own rendering services points and via retail net of points of services of agent systems and/or technical provider which could be either net of ATMs or system of automatic terminals.

There are well known methods of printed material distribution via addressed mail delivery, courier delivery of advertising informational materials to the home or work address or personal distribution of advertising informational materials in the appointed advertising places. Disadvantages of those methods as a rule passiveness and are non-specific way of advertising, limitations in terms of audience and criteria of the target group options, with high range of expenses for the production and distribution of printed materials with no guarantee of distribution which decreases the effectiveness of advertising materials and as follows to the decreasing of the interest of the advertiser to this kind of advertisement.

There are also known methods of electronic distribution of advertising informational materials which allows decrease expenses for the typographic production of the advertising handbills and human factor of distributing services. There are known methods of electronic distribution of informational materials particularly via distribution of advertising message to the subscribers of fixed and mobile connection with usage of on-line advertisement, SMS, MMS messages and etc. For example, there is a known method of distribution of advertising informational messages (RU 2192049, G09F 19/00, published 27.10.2002) which includes such operations of the method like provider of advertising informational messages and registration of the users of the advertising services in the base of administrate system which receives from the advertisers informational messages and terms of distribution specified by the advertiser and then sort and distribute the advertising informational messages to the specified groups and by the specified classifying indications. The terms of distribution of advertising messages specify the providers of the advertisement which include specifics of the social groups to which the messages are addressed, way of presentation of the advertising informational messages, possible language of appeal. The terms of distribution identify the administrative system including the format the size of the message.

The main disadvantages of known methods are mainly the original set of criteria of the audience identity, limited by the available through the providers passport information of the subscribers or holders of the sim card that do not guarantee data of the user and do not characterize his/her pay ability, besides, the advertising information is not related to another important for the client information which requires the analyses. Also, the theme of the advertisement is identified by the consumer and it limits the advertiser's possibilities.

Unlikely to the known methods of electronic distribution of the advertising informational materials the method of the application when the advertisement is aimed to the clients making the money transfer or payment gives the following advantages:
Usage of the financial document as the carrier of advertisement, that provide the guarantee of deliverance of information to the consumer (the client confirms with the signature the document's obtainment), and more attentive treatment of the user comparatively to the printed advertising materials delivered to the consumer in the bank or magazine;
Usage of the retailer agent system of payments' collection and/or money transfers and/or technical providers for the advertisement distribution, that allows the sorting and guarantees to the advertiser the deliverance of the advertising information to the people having free money available at the moment of advertisement received and as a result potential consumers, that is an advantage comparatively to the for instance mail delivery or delivery of the advertising information via mobile tool or Internet;
Possibility for the advertiser to control and manage the advertising company. For that the advertising module for each advertiser contains the personal page of the user available through the remote on-line access. The page enables advertiser to create and change the criteria of audience's sorting, download, change and save the advertising modules designed for the recently chosen audience as well as study the reports of the advertising module concerning the contacts by the sorted groups. Unlikely to the terminals of client's apply the access to the advertising module does not allow the advertiser the get access to the information concerning the money transfers or payments or financial module's data base.

Thus, the method of application is called to provide guarantee aimed contact with the final consumer of the advertising information counting the social portrait of the consumer. In other words, the higher reliability of the aimed audience sorting and deliverance to the addressee can be achieved. Besides, the advertiser gets better conditions of advertising informational services rendering, there is a possibility of on-line control of the advertising company process and possibility to change the aimed audience as well as the advertising modules, thus the effectiveness of the advertising informational materials can be achieved.

There is known system of advertisement deliverance via network painter (application USA US2008065477). The system connects two main communities. The first one is a target group; the second is the confirmed sources of information connected through the administrative system. There can be any amount of the communities in the system. The target group includes the network printer and many working stations used by many users. Each such station is connected to the network printer. The network printer includes controller with configuration allowing generating the title page which the network printer prints. The title page includes the sign of user identification for the printing task division. The confirmed source of information (data base of the advertisers) equipped with the tool of advertising messages' deliverance with connected with the controller of the network printer for the deliverance of the advertisement which is to be printed on the title page. And the advertisement is printed in addition to the identifying sign of the user previously printed on the page. The method includes for instance the following operationŝ receiving of the printing task from the working station, receiving of the advertising information from the advertiser, printing of the title page and printing of the main task. And the title page contains the advertising information and identifying sign which allows discern the printing tasks from different users. And the advertising information can be transferred in digital and analogue forms. Administrative system is mediator between the advertiser and target group limiting the direct access of the advertisement through testing of its source. Administrative system includes the tool of advertising information forwarding realized in the computer connected to the Internet. Administrative system has to have connection with the electronic system of target group in order to get permission for the forwarding of advertising information and tool of confirmation.

However, the known method uses the secondary title page as a carrier of information that reduces the guarantee of advertising information awareness it's characterized with the limited of the final users as it's a closed network solution and the method of the application is independent unlikely to the mentioned method from the connecting of a printer.

There is known the payment document used as a carrier of advertising information (RU 59874, GO9F 23/10 published 27.12.2006) however the reversed side is available for the advertising information shaped in two blocks one of those is a detached coupon. There is known a form of charitable bill which the charitable organizations send out. It contains the advertisement or logo of the organization (NL 8200844).

However none of the known methods is capable to provide the mentioned above technical result.

The technical result can be achieved through the delivery of advertising informational messages when money transfer services rendering and/or payments collection via connected through the Internet:

Informational system united by the technological solution the work of financial and advertising modules;

Advertising module that provide the selective transaction of the advertising messages aimed to the selected group of clients to the terminals of clients' apply for the printing on the hardcopy of electronic service form.

At least one source terminal of advertising messages supplied with access to the interface of advertising module for choosing of the clients' criteria, entering of allocating advertising modules and receiving of the reports;

At least one terminal of client's apply for the service supplied with access to the interface of informational system and printer for preparation and issue to the client the confirming financial document of the fulfilled transaction which the hardcopy of the electronic service form containing the advertising informational block.

The informational system includes: financial module responsible for the payment collection service and money transfers and giving authorization of transaction; the advertising module responsible for the conduction of the advertising activity; technological solution of interaction of the advertising and financial modules which allows from the remote terminal of application through the interface of informational system enter data of a client and advertising, and financial module at the same time, receive the authorization of transaction and as confirmation of service rendering print out the hardcopy of the electronic form containing the advertising module.

The advertising module includes:

Interface of advertiser available for the advertiser online from the remote terminal for independent download of the advertising modules and choosing of the selecting criteria of the audience;

Data base of advertisers with saved selective criteria of the target group and advertising modules;

Block of information processing consisting of the server, application programs and operational system which by the method of consecutive logic fulfills the algorithm of advertiser's selection fulfilling the check of match of clients' parameters and selection criteria of the target group and if positive selection of the advertising module matching the parameters of the printing device of the terminal of application and if negative fulfills the consecutive selection of other modules check of criteria or returns to the selection of another advertiser and check of its criteria and selection modules;

Data base of the clients which is formed of the data (received from the terminals of application) containing information about parameters of a client and of the links (received from the block of information processing) to the advertising module, attached to the certain client;

Block of reporting for the advertiser which by the request (received through the interface of advertiser) forms the reports about the occurred advertising contact (based on the information from data base of clients).

And terminal of clients' application besides the ban operator can be atomized device of payments collection or ATM.

And the advertising block is printed on the front of the document confirming the service rendering and the advertising block can be a voucher or discount coupon including bar-code of the good of the advertiser.

The method fulfillment includes the following operations: download of the advertising modules to the data base of the advertisers from the source terminal of the advertising messages and forming of the selecting criteria of the target group through the interface of advertiser in the advertising module of informational system.

Registration of clients' parameters on the terminals of application via entering of the client's data by the operator and/or client and/or automatically when entering identification data like PIN code or receiving of the electronic signal. Transaction or download of electronic data from the terminal of application through the interface of informational system first to the financial module for the authorization of transaction and after positive decision to the advertising module. The following comparison of client's parameters match with selecting parameters of the advertising modules and selection of the advertising module by the processing information block connected to the data base of advertisers. Selection of the format of the select advertising module in correspondence with the used printing device of the terminal of application. Layout of the hardcopy of the electronic form confirming the transaction with advertising module and transaction of the document to the printing device of the terminal of application. Data transaction including parameters of the client and link to the attached advertising module in data base of clients of advertising module in the informational system. Creation by the reporting block connected to the data base of the clients of information about the advertising contacts for the view in the interface of advertiser.

And the additional selecting criteria of target group of the particular advertising module besides passport data can be: electronic signal from the terminal of application appropriate to the amount of money received via electronic transaction; and/or electronic signal from the terminal of application appropriate to the activity profile of the legal entity receiver of the electronic transaction; and/or another additional parameter entered by the request of advertiser in the terminal of application.

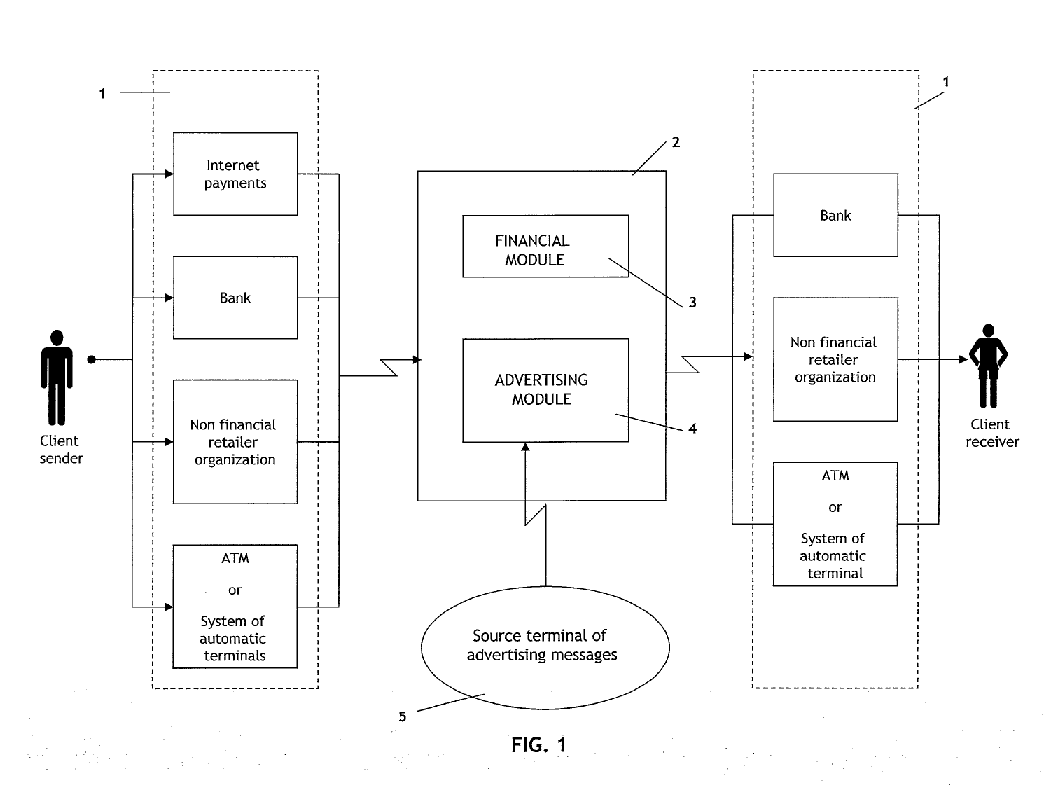

The system of realization and method of distribution of printed advertising informational messages is presented on the FIGS. 1-3.

The FIG. 1 presents the scheme of general interaction of all the participants of the distribution of advertising informational messages via the method of application. Where 1—the remote terminal of application and its possible variants; 2—united informational system with configuration which includes financial module—3 and advertising module—4; 5—source terminal of advertising messages.

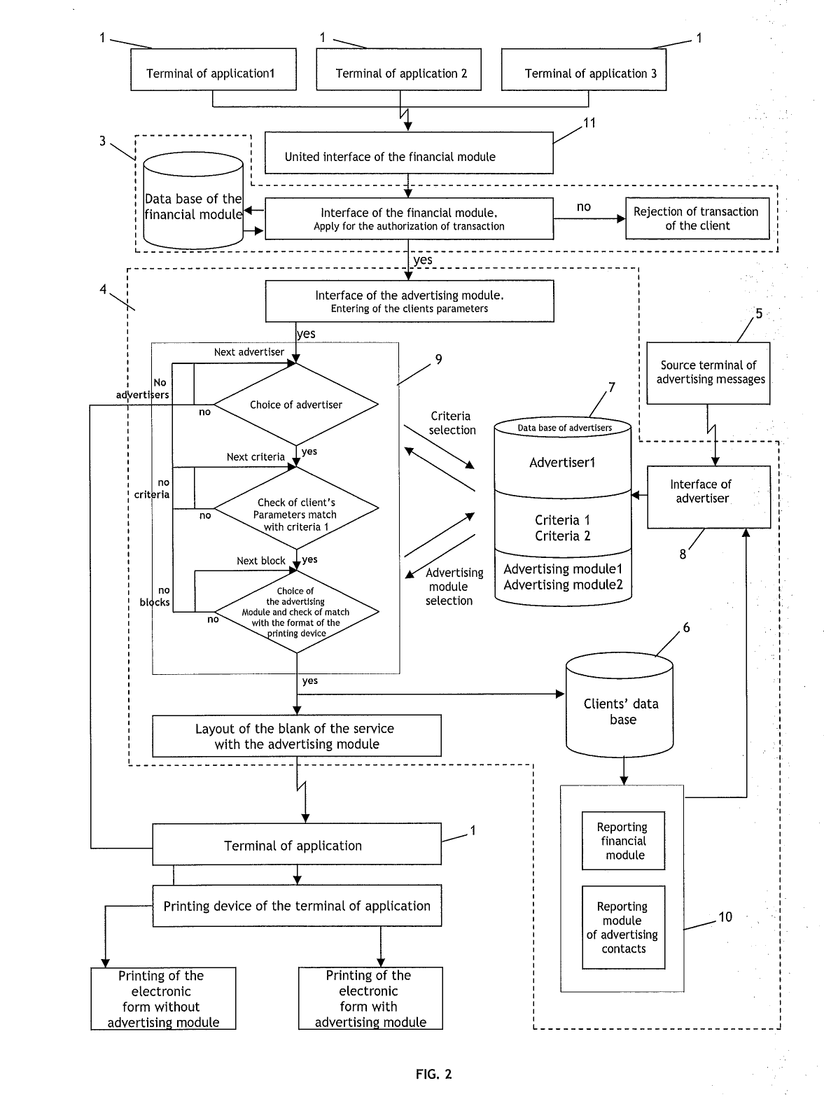

The FIG. 2 presents the algorithm of the work of the system and method of the distribution of advertising informational messages when money transactions and/or payments. Where 1—remote terminal of application; 11—interface of united informational system 2 for entering of data from terminals of application; 3—financial module; 4—advertising module which contains: 6—data base of clients with saved records about advertising contacts (parameters of client and link to the advertising module attached to the specified client); 7—data base of advertisers with recorded selecting criteria and advertising modules; 8—interface of advertiser through which download the messages, selecting criteria and through which the reports of reporting block can be viewed; 9—block of information processing fulfilling the check of criteria and selection of advertiser and advertising module; 10—reporting block of advertising contacts; 5—remote source terminal of advertising messages.

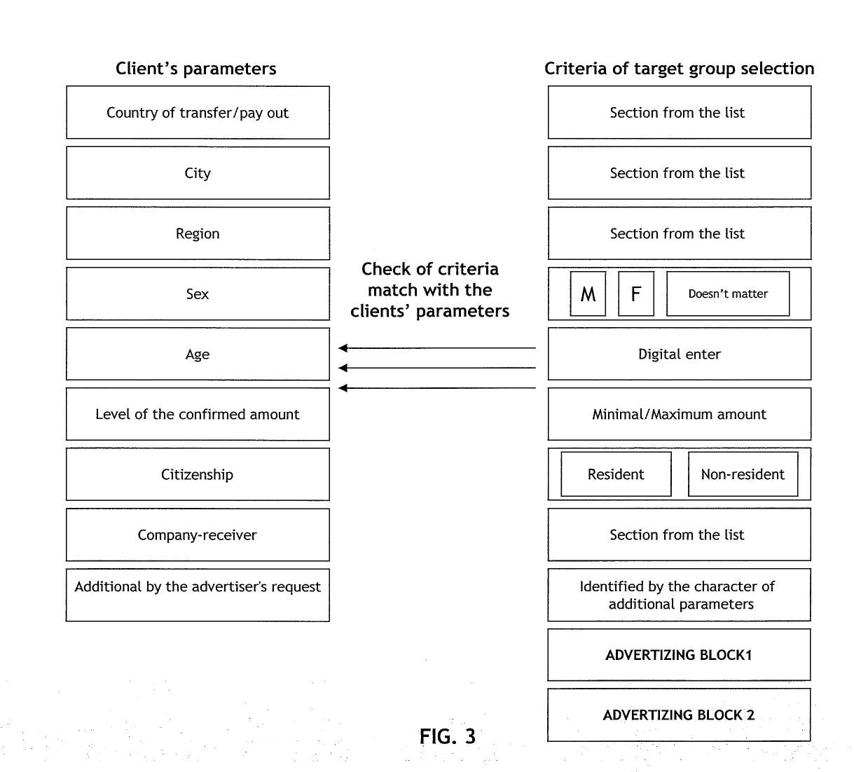

FIG. 3 presents scheme of selection of target group and checking algorithm of advertiser's criteria concerning client's compliance with parameters. Where from the remote source terminal of advertising messages 5 through the interface of advertiser 8 the advertiser enters criteria of target group selection and enters the advertising modules in the data base of advertisers 7. Where information about client's parameters comes from the terminal of application 1.

Method of transfer of advertising informational messages can be fulfilled in the following way:

Standard procedure supposes that the client 1 applies through the terminal of application to make the transaction and receives from the operator or automated apparatus of payments collection or ATM the financial document—hardcopy of electronic form confirming the fact of service rendering. According to the method of application to the hardcopy download the advertising informational block which is integral part of the hardcopy of the electronic form and print for the client on one page with it by the printer of terminal of application 1. When send or receive money to the individual (remittance) or legal entity (pay to the account) information about the client from terminal of application 1 through the united interface 11 of informational system 2 comes to the financial module 3 first, after that if the transaction is authorized comes to the advertising module 4 in the block of Information 9.

And from database of advertisers 7 of the advertising module 4 is selecting the advertising informational module addressed to the certain client and applicable for certain printing device of the terminal of application, module appears on the window of the terminal of application (administrator can switch off the option of advertising informational module appearing in the window of the terminal) before the authorization of transaction. Technologically printed advertising informational module comes out on the hardcopy of the electronic form confirming the service rendering. Printed hardcopy of the electronic form confirming the rendered service is a financial document printed for the client (with the mark and seal of the terminal of application) and if the terminal of application is a bank of non-financial retailer organization the second copy is printed for the agent (signed by the client). Printed hardcopy with the advertising informational materials is handed to the client from the terminal of application and in the case of money transfer receiving with the transferred amount of money.

Data about the contact (client's parameters and link to the attached file) from block of information processing 9 comes to the clients' data base 6 and data from it can be required by the reporting block 10 available for the advertiser through the remote source terminal of advertising messages 5 via access through the interface of advertisers 8.

Formula of the Invention

1. System of distribution of printed advertising informational messages when money transfers and payments including connected via Internet:
Informational system realized in operational system on server including financial module which provides services of payments collection and/or money transfers and fulfills authorization of transactions and advertising module which provides selective transaction of advertising modules agreeable to the pointed by advertiser criteria of group of clients to the printer of terminal of application;
at least one source terminal of advertising messages with the access to the interface of advertiser in the advertising module of informational system;
at least one remote terminal of application with access to the united interface of informational system and equipped with the printing device to print and hand out the hardcopy of the electronic form confirming the transaction to the client;
And the advertising module includes: interface of advertiser; data base of advertisers with recorded criteria of target groups and advertising modules, block of processing, comparison and selection of information, fulfilling the check of compliance of the parameters of client with criteria chosen by the advertiser of the target group when data from terminal of application comes if the is a match checks the selection of advertising module matching the parameters of the printing device of the terminal of application.

2. System of distribution of printed advertising informational messages by item 1 distinguished with the advertising module of informational system includes: data base of clients, with recorded parameters of client and links to the attached advertising module, coming from the block of information processing saved in clients' data base, by the request of advertiser forms the reports of the advertising contacts.

3. System of distribution of printed advertising informational messages by item 1 distinguished with terminal of application which is a desk of bank operator.

4. System of distribution of printed advertising informational messages by item 1 distinguished with terminal of application which is a desk of non-financial retailer company's operator.

5. System of distribution of printed advertising informational messages by item 1 distinguished with terminal of application which is a atomized apparatus of payments collection.

6. System of distribution of printed advertising informational messages by item 1 distinguished with terminal of application which is an ATM.

7. System of distribution of printed advertising informational messages by item 1 distinguished with advertising module printed on the front page of the hardcopy of the electronic form which is a confirming document of the service rendered.

8. System of distribution of printed advertising informational messages by item 1 distinguished with advertising module is a voucher.

9. System of distribution of printed advertising informational messages by item 1 distinguished with advertising module is a discount coupon for the goods of advertiser.

10. System of distribution of printed advertising informational messages by item 1 distinguished with discount coupon contains the bar codes of the goods of the advertiser.

11. Method of distribution of printed advertising informational messages when money transfers and payments including:
download of advertising modules to the data base of advertisers and forming of the selective criteria for the target group from the remote source terminal of advertising messages through the interface of advertiser in the advertising module of the information system, registration of clients' parameters through the united interface of informational system from the remote terminal of application with the following entering of the clients parameters to the financial and if authorized transaction to the advertising module with the following choice of the advertiser by the block of information processing module of the advertising module, check of compliance of the clients' parameters to the selective criteria of the target group, selection of the advertising module, selection of the format of the selected advertising module according to the printing device of the terminal of application, layout of the printed hardcopy of the electronic form confirming the transaction with chosen advertising module forwarded to the printing device of the terminal of application.

12. Method of distribution of printed advertising informational messages by item 11 is distinguished with included operation of reporting by the reporting block connected with data base of clients' data of advertising contacts for the view through the interface of advertiser.

13. Method of distribution of printed advertising informational messages by item 11 is distinguished with the selective criteria for the target group of the advertising module based on the given by the advertiser geographic principal.

14. Method of distribution of printed advertising informational messages by item 11 is distinguished with the selective criteria for the target group of the advertising module based on the given by the advertiser concrete or complex personal data of the client.

15. Method of distribution of printed advertising informational messages by item 11 is distinguished with the selective criteria for the target group of the advertising module based on the given by the advertiser amount transferred and/or enter in an account.

16. Method of distribution of printed advertising informational messages by item 11 is distinguished with the selective criteria for the target group of the advertising module based on the given by the advertiser profile of the activity of the legal entity receiver of the money when entering in the account.

17. Method of distribution of printed advertising informational messages by item 11 is distinguished with the selective criteria for the target group of the advertising module based on the given by the advertiser concerning the concrete advertising module.
